(19) United States
(12) Patent Application Publication
(10) Pub. No.: US 2024/0392203 A1
(43) Pub. Date: Nov. 28, 2024

(54) Biogas Upgrading by Method of Hydrocarbon Gas Dilution

(71) Applicant: VisionRNG LLC, Canonsburg, PA (US)

(72) Inventors: Jeremy Snyder, Canonsburg, PA (US); Robert Hodgkiss, Canonsburg, PA (US)

(21) Appl. No.: 18/323,366

(22) Filed: May 24, 2023

(51) Int. Cl. C10L 3/10

(52) U.S. Cl. CPC C10L 3/10; C10L 2200/0469; C10L 2290/30; C10L 2290/60

(57) ABSTRACT

A method for upgrading biogas comprising: providing a pretreated biogas stream; providing a natural gas stream; controlling a pressure and a flow of the pretreated biogas stream; controlling a pressure and a flow of the natural gas stream; blending together the pretreated biogas stream and the natural gas stream to create a blended gas product; analyzing the blended gas product to determine if a plurality of tariff parameters are substantially met; adjusting an actual ratio of the pretreated biogas stream to the natural gas stream, such that the blended gas product meets the plurality of tariff parameters, such that a renewable natural gas product is created. One of the two gas streams may be compressed before blending and the blended gas may be compressed after blending.

### FIELD OF THE DISCLOSURE

The present disclosure relates to a method of upgrading biogas into a resalable form of renewable natural gas (RNG). More specifically, the present disclosure relates to a method of blending partially purified biogas with hydrocarbon gases to create RNG. Performing biogas upgrading by means of blending reduces purification costs and equipment needs and increases the efficiency of RNG production.

### BACKGROUND

The process of reducing the number of non-methane components in a biogas may be known as upgrading biogas. Existing methods for upgrading biogas commonly include harvesting raw untreated biogas from sources such as landfills or digesters. The biogas is first partially purified and then transported to a hub center where the partially purified biogas is further processed and refined to standards acceptable for injection into natural gas distribution systems. The purification process frequently requires costly filters and excess equipment and is overly complicated. In typical variations, compression systems pass partially purified natural gas through membranes to extract contaminants not removed from the partial purification process. This process requires motors, compressors, and multistage filtration units. Many variations also require the removal and distribution of carbon dioxide. Compression and multistage filtration processes require extra energy, equipment, maintenance, space, upkeep, and ongoing human or computer monitoring.

Thus, what is needed is a biogas upgrade method that reduces non-methane constituents to levels acceptable for injection into natural gas distribution systems without secondary purification.

### SUMMARY

The present disclosure is directed to a method of reducing non-methane constituents to levels acceptable for injection into natural gas distribution systems. Utilizing chromatographs to monitor the biogas stream, flow, and/or pressure, control valves can be controlled to blend hydrocarbon gas with the biogas to meet tariff parameters. A plurality of flow and/or pressure control valves installed at the inlets of the biogas and hydrocarbon gas may be measured using a chromatograph before gas blending. The composition of the separate gases will determine whether an increase or decrease in pressure and/or flow of the valve(s) is required to achieve the desired blend ratio in order to meet the tariff gas composition requirements. These requirements can include, but are not limited to, the minimum and maximum heating value measured as a British Thermal Unit (“BTU”), Wobbe minimum and maximum, total sulfur, hydrogen sulfide, carbon dioxide, nitrogen, oxygen, and total inert gases percent composition within the gas stream. The Wobbe index (WI) or Wobbe number is an indicator of the interchangeability of fuel gases, such as natural gas, liquefied petroleum gas (LPG), and town gas, and is usually defined in the specifications of gas supply and transport utilities. Town gas is mostly made of hydrogen and methane and is man-made.

One embodiment of the present disclosure may be a method of upgrading biogas comprising: providing a pretreated biogas stream; providing a natural gas stream; controlling a pressure and a flow of the pretreated biogas stream; controlling a pressure and a flow of the natural gas stream; compressing the pretreated biogas stream; blending together the compressed pretreated biogas stream and the natural gas stream to create a blended gas product; analyzing the blended gas product to determine if a plurality of tariff parameters are substantially met; and adjusting automatically an actual ratio of the compressed pretreated biogas stream to the natural gas stream in response to the analyzing of the blended gas product, such that the blended gas product meets a plurality of tariff parameters, such that a renewable natural gas product is created. The method of upgrading biogas may further comprise providing the tariff parameters before blending; analyzing the pretreated biogas stream before blending; analyzing the natural gas stream before blending; and determining an optimal ratio of the pretreated biogas stream to the natural gas stream that will meet the tariff parameters. The blending may be done at the optimal ratio that was determined. The adjusting of the actual ratio of the pretreated biogas stream to the natural gas stream may be done via adjusting the pressure and the flow of the pretreated biogas stream and adjusting the pressure and the flow of the natural gas stream. The analyzing of the blended gas product may be done via gas chromatography. The method may further comprise compressing the blended gas product. The pretreated biogas may be obtained from at least one of a landfill, an industrial waste site, and an agricultural waste site.

Another embodiment of the present disclosure may be a method of upgrading biogas that may comprise: providing a pretreated biogas stream; providing a natural gas stream; controlling a pressure and a flow of the pretreated biogas stream; controlling a pressure and a flow of the natural gas stream; compressing the pretreated biogas stream; blending together the compressed pretreated biogas stream and the natural gas stream to create a blended gas product; compressing the blended gas product; analyzing the blended gas product to determine if a plurality of tariff parameters are substantially met; and adjusting automatically an actual ratio of the compressed pretreated biogas stream to the natural gas stream in response to the analyzing of the blended gas product, such that the blended gas product meets the tariff parameters, such that a renewable natural gas product is created; wherein the pretreated biogas may be obtained from at least one of a landfill, an industrial waste site, and an agricultural waste site. The method may further comprise providing the tariff parameters before blending; analyzing the pretreated biogas stream before blending; analyzing the natural gas stream before blending; and determining an optimal ratio of the pretreated biogas stream to the natural gas stream that will meet the tariff parameters. The blending may be done at the optimal ratio that was determined. The adjusting of the actual ratio of the pretreated biogas stream to the natural gas stream may be done via adjusting the pressure and the flow of the pretreated biogas stream and adjusting the pressure and the flow of the natural gas stream. The analyzing of the blended gas product may be done via gas chromatography. The method may further comprise transporting the renewable natural gas product to a gas pipeline interconnect.

Another embodiment of the present disclosure may be a method for upgrading biogas comprising: providing a pretreated biogas stream; providing a natural gas stream; controlling a pressure and a flow of the pretreated biogas stream; controlling a pressure and a flow of the natural gas stream; blending together the pretreated biogas stream and the natural gas stream to create a blended gas product; analyzing the blended gas product to determine if a plurality of tariff parameters are substantially met; and adjusting an actual ratio of the pretreated biogas stream to the natural gas stream, such that the blended gas product meets the tariff parameters, such that a renewable natural gas product is created. The method may further comprise: providing the tariff parameters before blending; analyzing the pretreated biogas stream before blending; analyzing the natural gas stream before blending; and determining an optimal ratio of the pretreated biogas stream to the natural gas stream that will meet the tariff parameters; wherein the blending may be initially done at the optimal ratio that was determined. The method may further comprise transporting the renewable natural gas product to a gas pipeline interconnect. Adjusting the actual ratio of the pretreated biogas stream to the natural gas stream may be done via adjusting the pressure and the flow of the pretreated biogas stream and adjusting the pressure and the flow of the natural gas stream. The pretreated biogas may be obtained from at least one of a landfill, an industrial waste site, and an agricultural waste site. The analyzing of the blended gas product may be done via gas chromatography. Adjusting the actual ratio of the pretreated biogas stream to the natural gas stream may be done automatically in response to the analyzing of the blended gas product. The method may further comprise compressing either the pretreated biogas stream or the natural gas before blending them together. The pretreated biogas stream may be compressed, and the natural gas may be uncompressed. Alternatively, both the biogas stream and the natural gas stream may be uncompressed before blending. The method may further comprise compressing the blended gas product. The method may further comprise compressing the blended gas product. The renewable natural gas product may be (i) a merchantable natural gas that may be substantially free of water and liquid hydrocarbons, (ii) contains no more than 7 pounds of water vapor per MMcf, (iii) contains no more than 1.0 grain of hydrogen sulfide, (iv) contains no more than 20 grains of total sulfur per 100 cubic feet, (v) no more than 2% carbon dioxide (by volume), (vi) contains no more than 50 parts per million of oxygen, (vii) contains no active bacteria or bacterial agents, contains no hazardous or toxic substances, and (viii) have a total or gross heating value of not less than nine hundred and fifty (950) BTU and not more than one thousand two hundred (1,200) BTU per cubic foot.

Another embodiment may be a method for upgrading biogas comprising: obtaining a pretreated biogas; inputting pretreated biogas into a blending system; controlling flow and pressure of the pretreated biogas; maintaining the pretreated biogas input pressure between 65 and 120 pounds per square gauge (“psig”, which is a pressure measurement that is measured relative to ambient atmospheric pressure), creating a first chromatograph of pretreated biogas; inputting a hydrocarbon gas for diluting pretreated biogas; creating a first chromatograph of hydrocarbon gas for diluting; adjusting flow and pressure control of pretreated biogas to maintain a ratio applicable to dilute the gas stream to tariff specifications, which can range to 5:1; adjusting flow and pressure control of hydrocarbon gas for diluting to maintain a 5-1 ratio; creating a first chromatograph of blended pretreated biogas and hydrocarbon gas for diluting; meeting the tariff parameter; outputting the acceptable RNG product. The pretreated biogas may comprise methane; carbon dioxide; hydrogen sulfide; hydrogen; nitrogen; oxygen; carbon monoxide; ammonia; siloxanes; and water. The water may be removed. The hydrogen sulfide may be removed. The blending system may have a plurality of valves, where the plurality of valves may be adjusted according to a chromatograph monitor. The ratio may be between 1-to-1 and 8-to-1. The tariff parameters may comprise of one or more of the following depending on the specifications of the gas utility company: RNG product free of water and liquid hydrocarbons; less than 7 pounds of water vapor per one million standard cubic feet (MMcf); no more than 1.0 grain of hydrogen sulfide; no more than 20 grains of total sulfur per 100 cubic feet; no more than 2% of carbon dioxide; no more than 50 parts per million of oxygen; shall not contain any active bacteria or bacterial agent; shall not contain any hazardous or toxic substances; and a gross heating value between 950 BTU and 1,200 BTU.

Another embodiment may be a method for upgrading biogas comprising: obtaining a pretreated biogas; removing water from pretreated biogas; removing hydrogen sulfide from pretreated biogas; inputting pretreated biogas into a blending system; controlling flow and pressure of pretreated biogas; maintaining pretreated biogas input pressure between 65 and 120 psig; creating a first chromatograph of pretreated biogas; compressing pretreated biogas at a first-stage compressor; removing oil from compressed pretreated biogas; inputting a hydrocarbon gas for diluting pretreated biogas; creating a first chromatograph of hydrocarbon gas for diluting; adjusting flow and pressure control of pretreated biogas to maintain a 4-to-1 ratio; adjusting flow and pressure control of hydrocarbon gas for diluting to maintain a 4-to-1 ratio; creating a first chromatograph of blended pretreated biogas and hydrocarbon gas for diluting; meeting the tariff parameter; outputting the RNG product. The first-stage compressor pressure may be maintained between 200 and 400 psig. Where the blending system may be maintained by the second-stage compressor. Where the first-stage compressor may be adjusted according to a chromatograph monitor. Where the ratio may be between 1-to-1 and 8-to-1. The tariff parameters comprise one or more of the following: RNG product free of water and liquid hydrocarbons; less than 7 pounds of water vapor per MMcf; less than 1.0 grain of hydrogen sulfide; less than 20 grains of total sulfur per 100 cubic feet; less than 2% of carbon dioxide; less than 50 parts per million of oxygen; shall not contain any active bacteria or bacterial agent; shall not contain any hazardous or toxic substances; and a gross heating value between 950 BTU and 1,200 BTU.

Another embodiment may be a method for upgrading biogas comprising: obtaining a pretreated biogas; removing water from pretreated biogas; removing hydrogen sulfide from pretreated biogas; input pretreated biogas into a blending system; controlling flow and pressure of pretreated biogas; maintaining pretreated biogas input pressure between 65 and 120 psig; creating a first chromatograph of pretreated biogas; compressing pretreated biogas at a first-stage compressor; removing oil from compressed pretreated biogas; input a hydrocarbon gas for diluting pretreated biogas; creating a first chromatograph of hydrocarbon gas for diluting; adjusting flow and pressure control of pretreated biogas to maintain a 4-1 ratio; adjusting flow and pressure control of hydrocarbon gas for diluting to maintain a 4-1 ratio; creating a first chromatograph of blended pretreated biogas and hydrocarbon gas for diluting; compressing blended biogas and hydrocarbon gas at a second-stage compressor; meeting the tariff parameter; outputting the RNG product. Where the second-stage compressor pressure may be maintained between 380 and 600 psig. Where the blending system may be maintained by the second-stage compressor. Where the second-stage compressor may be adjusted according to a chromatograph monitor. Where the ratio may be between 1-to-1 and 8-to-1. The tariff parameters may comprise one or more of the following: the RNG may be free of water and liquid hydrocarbons; less than 7 pounds of water vapor per MMcf; 1.0 grain of hydrogen sulfide; 20 grains of total sulfur per 100 cubic feet; 2% of carbon dioxide; 50 parts per million of oxygen; shall not contain any active bacteria or bacterial agent; shall not contain any hazardous or toxic substances; and a gross heating value between 950 BTU and 1,200 BTU.

Still, other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments, and its several details are capable of modifications in various obvious embodiments, all without departing from or limiting the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration depicting possible sources of biogas and showing one embodiment of a process diagram of the present disclosure.

FIG. 2 is a table of one embodiment showing typical biogas compositions and ranges.

FIG. 3 is a flow block diagram of one embodiment of the method of the present disclosure.

FIGS. 4a-4c are a functional diagram of one embodiment of the process flow of the raw biogas being partially processed before it is diluted.

FIGS. 4d-4g are a table showing one embodiment of the stream materials, properties, and mass flow.

FIG. 5 is a flow block diagram of one embodiment of the method of biogas upgrading via blending without compression.

FIG. 6 is a detailed block diagram of the single stage compression biogas upgrading process.

FIG. 7 is a detailed block diagram of the two-stage compression biogas upgrading process.

FIGS. 8a-8e are a functional diagram of one embodiment of the blending, injection piping, and instrumentation of the two-stage compression biogas upgrading process.

FIG. 8f is a table showing one embodiment of the stream materials, properties, and mass flow for the biogas dilution method of the present disclosure.

FIG. 9a-9b are a functional diagram of one embodiment of the blending, injection piping, and instrumentation of the two-stage compression biogas upgrading process of FIG. 7.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5 percent of the indicated number or range of numbers. In one embodiment, the term “approximately” and “about”, may refer to a deviance of between 0.001-40 percent from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Biogas is an environmentally friendly and renewable energy source resulting from the decomposition of organic matter. Biogas primarily consists of methane and carbon dioxide but may include several other compounds such as nitrogen, water, hydrogen sulfide, ammonia, hydrogen, and carbon monoxide. When stripped of non-methane constituents, the resulting methane-rich gas is flammable and can transfer energy.

The present disclosure describes methods of reducing non-methane constituents to levels acceptable for injection into natural gas distribution systems. Utilizing chromatographs to monitor the biogas stream, flow and/or pressure control valves can be controlled to blend hydrocarbon gas with the biogas to meet tariff parameters. The method of the present disclosure utilizes flow and/or pressure control valves installed at the inlets of the biogas and hydrocarbon gas. The gases may be separately measured using a chromatograph to determine their composition. The separate gas compositions will determine whether an increase or decrease in pressure and/or flow of the valve(s) may be required to achieve the desired blend ratio in order to meet the tariff gas composition requirements. These requirements can include but are not limited to a minimum and maximum heating value (BTU), Wobbe minimum and maximum, total sulfur, hydrogen sulfide, carbon dioxide, nitrogen, oxygen, and total inert gases percent composition within the gas stream. This method of upgrading biogas to renewable natural gas (“RNG”) has the benefit of being a more straightforward implementation, more energy efficient, and being more cost-efficient, primarily due to the elimination of expensive membrane filters.

As used herein the term “biogas” refers to any mixture of gases, primarily consisting of methane, carbon dioxide or hydrogen sulfide, which may be produced from raw materials such as agricultural waste, manure, municipal waste, plant material, sewage, green waste, wastewater, and food waste. Commonly referred to as marsh gas, sewer gas, compost gas and swamp gas.

As used herein the term “hazardous or toxic substances” refers to any hazardous substance that is ignitable, corrosive, reactive, or toxic. A toxic substance is a substance or waste that when ingested or absorbed, or otherwise in contact with a person may be fatal and harmful to the person.

As used herein the term “pretreated biogas” may refer to any process in which raw biogas is initially purified, which may comprise removing at least one of carbon dioxide (“CO₂), hydrogen sulfide (“H₂S”), Nitrogen (“N₂”), or water (“H₂O”) from the biogas.

As used herein the term “natural gas” refers to any odorless gas, gaseous mixture of hydrocarbons—predominantly made up of methane including but not limited to methane, ethane, butane, and propane.

The following detailed description of example implementations refers to the accompanying drawings. The same reference numbers in different drawings can identify the same or similar elements.

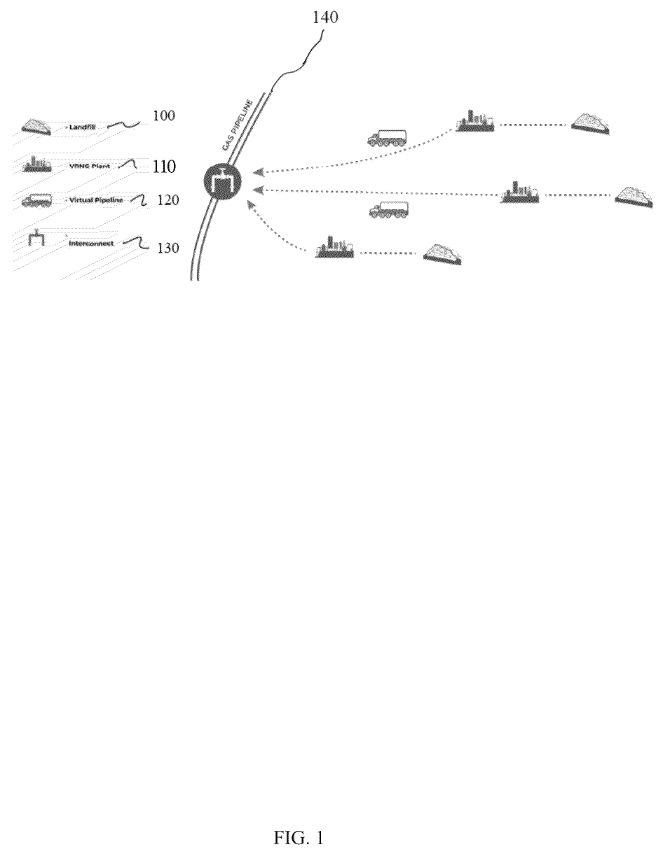

FIG. 1 is an illustration depicting sources of biogas and a diagram of biogas blending and interconnect. As shown in FIG. 1 raw biogas may be captured and initially processed (partially purified) at landfills 100, which may be actual landfills, agricultural waste sites, or industrial waste sites. The initial processing before transportation, typically includes a purification process, which may comprise removing at least one of carbon dioxide (“CO₂), hydrogen sulfide (“H₂S”), Nitrogen (“N₂”), or water (“H₂O”) from the biogas. The partially purified biogas arrives at VRNG plant 110 where it is blended with natural gas (NG) that already meets tariff and purity requirements. After blending, to meet tariff parameters, the blended biogas is then transported via pipelines and/or virtual pipelines (such as trucks) 120 to the interconnect hub 130 as an RNG product. The biogas received at the VRNG plant 110 is not further purified, only diluted, which has never been done on a large commercial scale before the present disclosure.

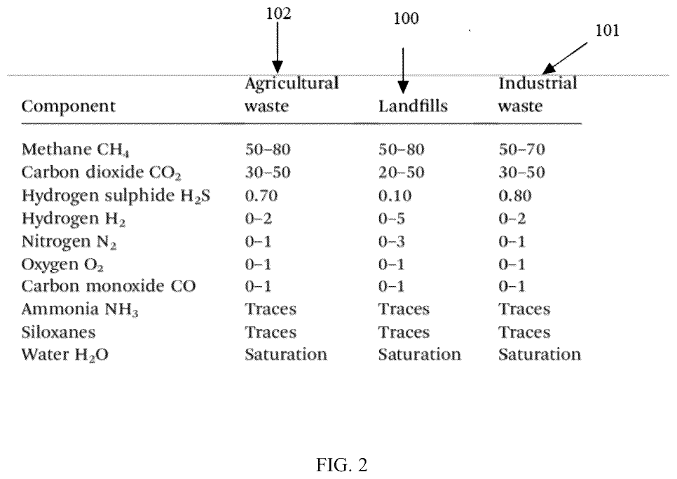

FIG. 2 is a table of typical raw biogas compositions. FIG. 2 shows embodiments of a typical biogas composition of landfills 100, industrial waste sites 101, and agricultural waste sites 102. The biogas compositions may comprise, in the ranges shown in FIG. 2, methane (“CH₄”), carbon dioxide (“CO₂), hydrogen sulfide (“H₂S”), Hydrogen (“H₂”), Nitrogen (“N₂”), Oxygen (“O₂”), carbon monoxide (“CO”), ammonia (“NH₃”), siloxanes, and water (“H₂O”). Partial processing or purification, before transportation, may comprise removing at least one of carbon dioxide (“CO₂), hydrogen sulfide (“H₂S”), Nitrogen (“N₂”), or water (“H₂O”) from the biogas.

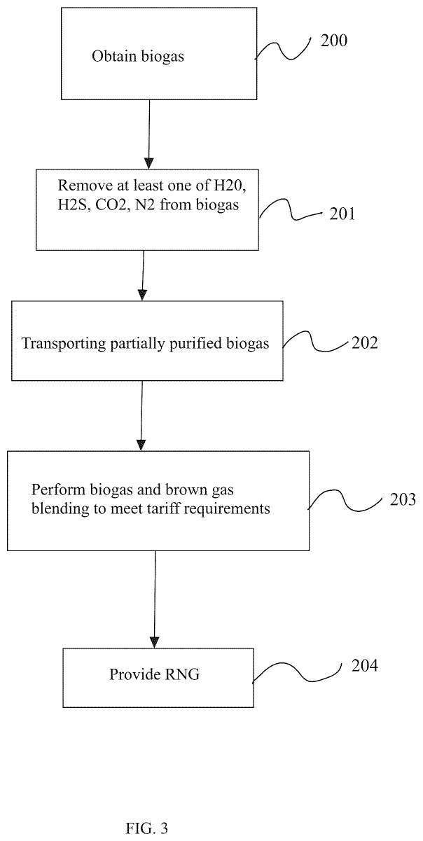

FIG. 3 is a block diagram of the process in the present disclosure. The method may comprise obtaining biogas 200, removing 201 of at least one component of raw biogas from landfill 100, industrial waste 101, or agricultural waste 102. Transporting the partially purified biogas 202 to a VRNG plant 110 for blending. Performing biogas and brown gas (which is a term for natural gas that has not been produced in a responsible or renewable manner) blending to meet tariff requirements 203, which results in renewable natural gas (RNG). Finally, providing the RNG 204, typically by supplying it to commercial gas pipeline.

In obtaining biogas 200 at its source from landfills 100, industrial waste 101, or agricultural waste 102 as raw biogas, which typically has the following components: CH₄, CO₂, H₂S, H₂, N₂, O₂, CO, NH₃, and H₂O, it is desirable to remove at least one (or more) component to create a partially treated biogas 201. Removing H₂O or H₂S via a purification method reduces corrosion problems and safety issues during transportation. Removing CO₂ can improve the compression process and/or allow more methane to be transported per unit of volume at a given pressure, thus reducing costs. The partially purified gas, which is not tariff ready or approved, may then be transported 202 to or collected at a VRNG plant 110. The VRNG plant 110 may be co-located with or located substantially near the source of the raw biogas. This cuts down on transportation 202 costs.

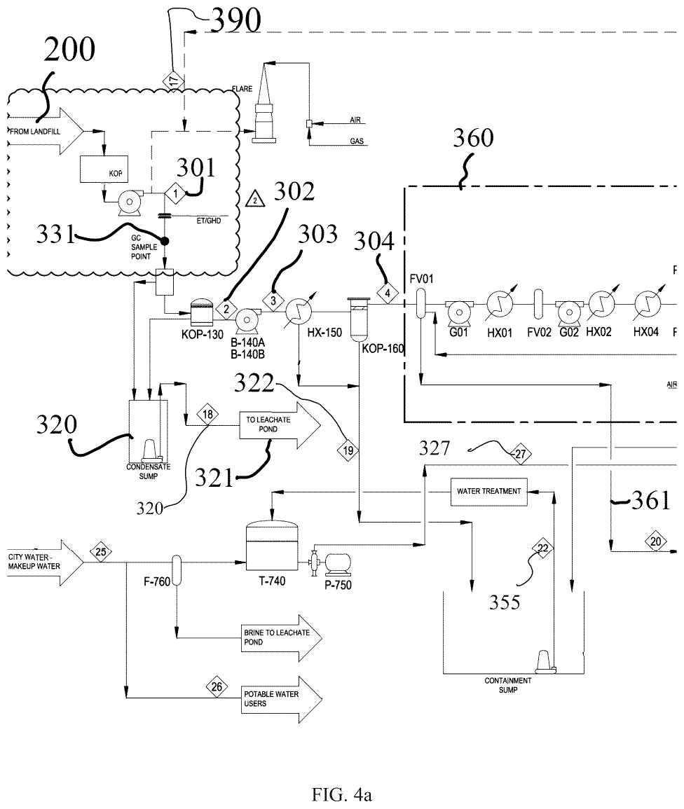

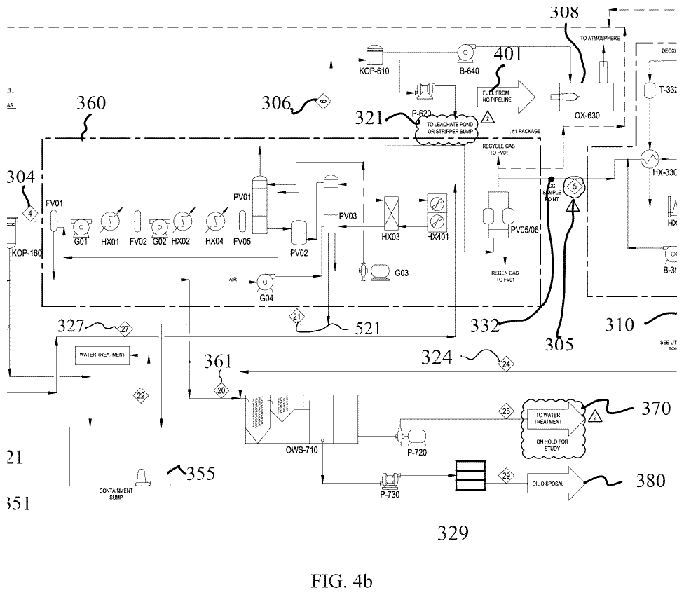

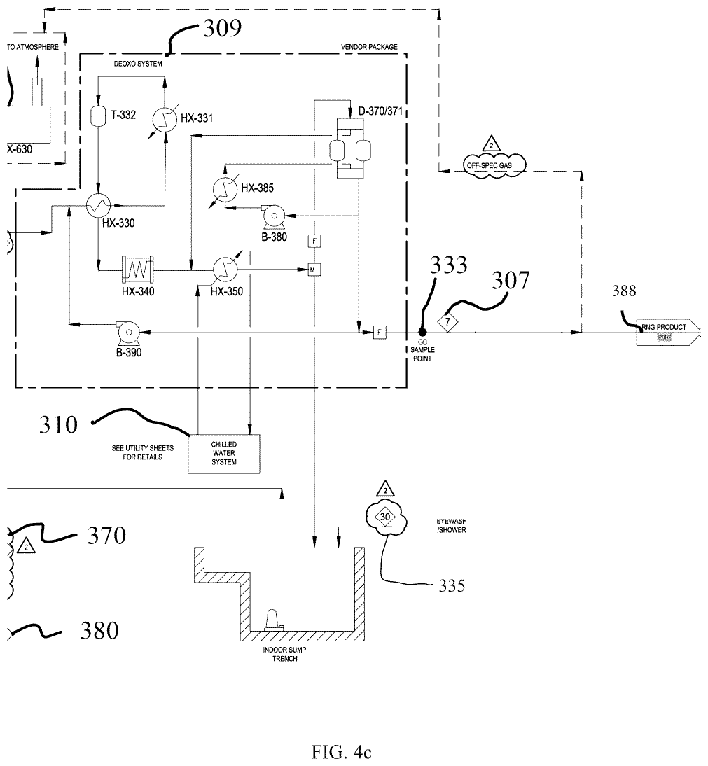

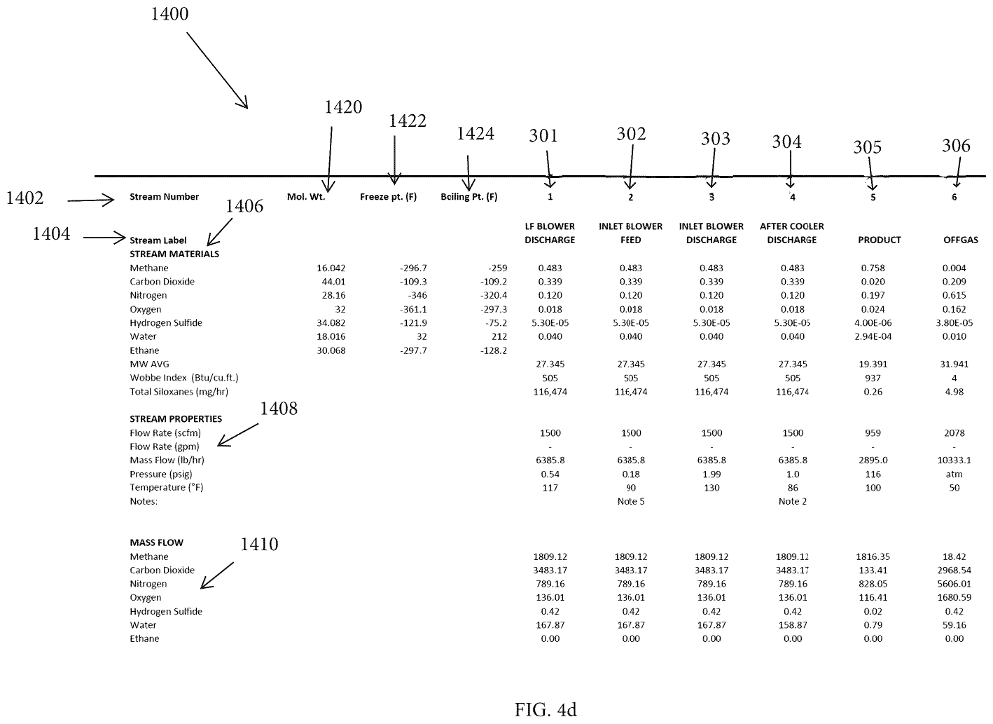

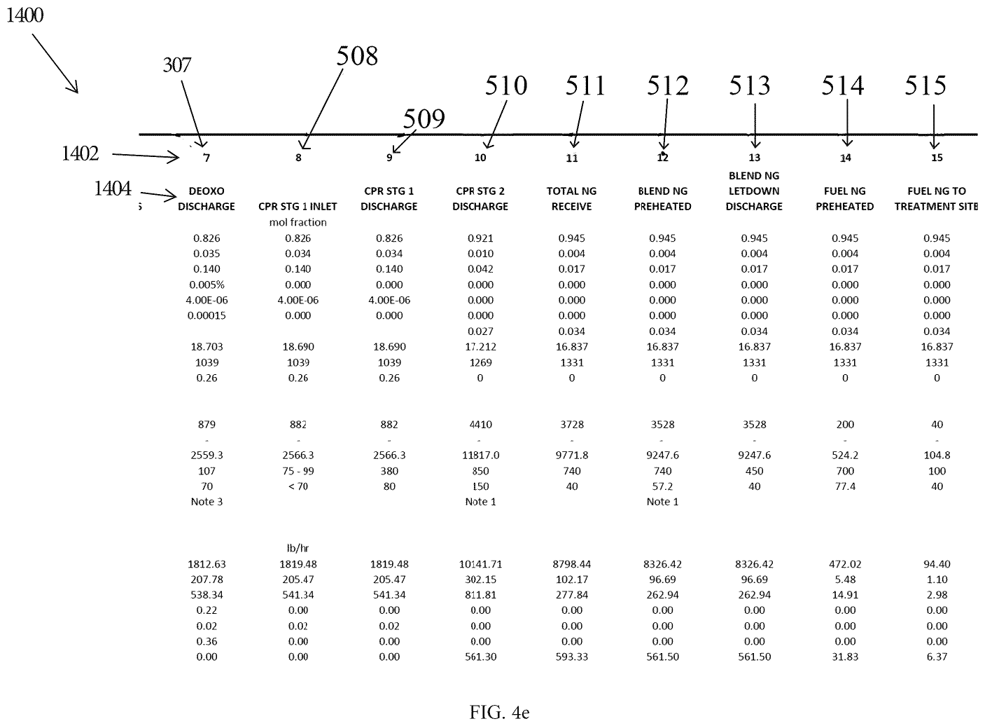

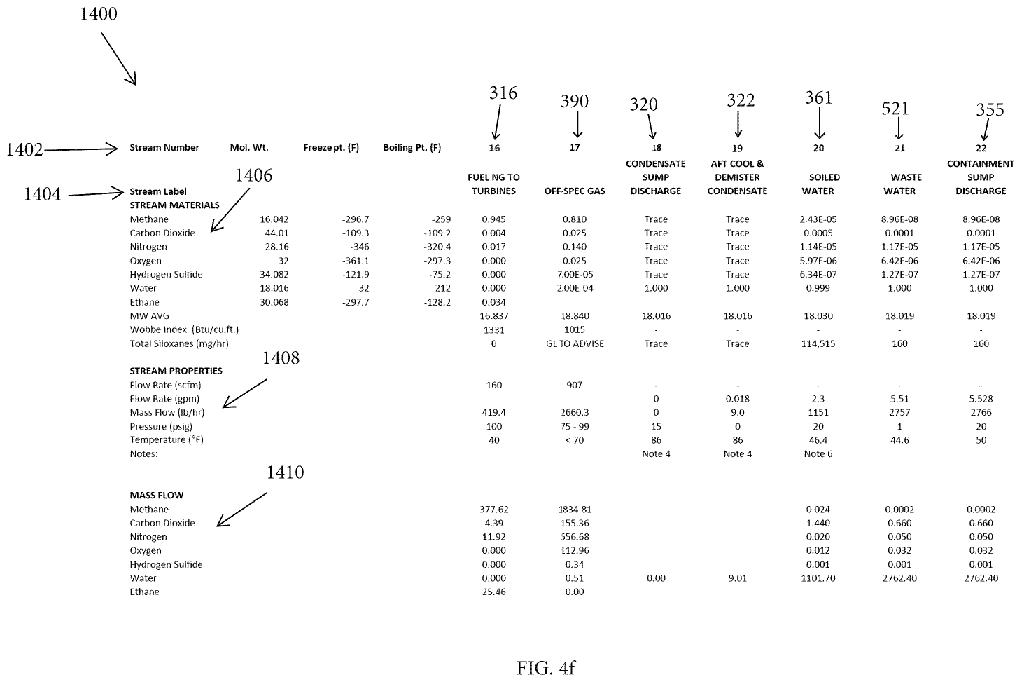

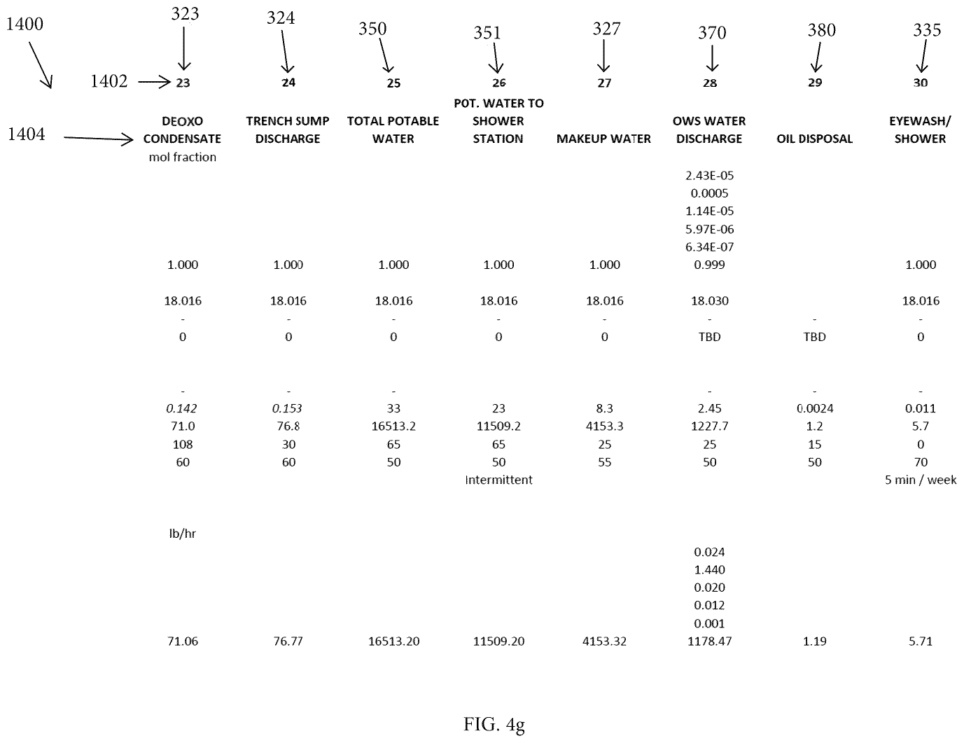

FIGS. 4a-4c are a functional diagram of one embodiment of the process flow of the raw biogas being partially processed before it is diluted.

### Alphanumeric Legend for FIGS. 4a-4c

KOP-130 is an inlet knockout POT
B-140A are booster blowers
HX-150 is a booster aftercooler
B-140B is a booster blower stand-by
KOP-160 is a booster aftercooler knockout pot
FV01 is an inlet separator
G01/G02 is an absorber feed compressor
HX01/HX02/HX04 are absorber feed coolers
PV01 is an absorber
PV02 is an absorber discharge flash tank
PV03 is a stripper
G04 is a stripper blower
G03 is a water circulation pump
HX03/HX401 are circulation water coolers
PV05/06 are desiccant dryers
KOP-610 is an oxidizer feed knockout pot
P-620 is an oxidizer KO condensate pump
OX-630 is a thermal oxidizer
B-640 is an oxidizer blower
OWS-710 is an oil separator
P-720 oil water separator discharge pump
P-730 oil discharge pump
B-380 is a regeneration lower
HX-330 is an economizer
HX-385 is a regeneration heat
T-332 is a DEOXO catalyst bed
HX-331 is an electric heater
D-370/371 is a TSA Dryer
HX-340 is an air-cooled cooler
HX-350 is a chilled water cooler
B-390 is a recycle blower
P-750 is a makeup water tank discharge pump
T-740 is a makeup water storage tank
F-760 is a make-up water softener

As shown in FIGS. 4a-4c, the obtained raw biogas 200 may be input into LF (landfill) Blower Discharge 301 at a pressure of 0.54 psig, where it may be sampled and sent to a gas chromatograph which may monitor CH₄, O₂, N₂, H₂0, H₂S, siloxanes in the collected raw biogas along with the BTU value of the gas. The ranges monitored will vary from but are typically 50-52 percent CH₄, 1-1.9 percent O₂, 8-14 percent N₂, 32-42 percent CO₂, <2000 ppm H₂S, and siloxanes −5 mg/M³ Si. In this case, FIGS. 4e-4h, which are a table of the stream materials, properties, and mass flow, show that the entering raw biogas is 48.3% methane.

Condensate/water are removed from the gas stream as waste and are removed through a condensate sump discharge 320 pump. The biogas 200 continues to an inlet blower feed 303 and then through an aft cool and demister condensate 322, where it may be cooled, and moisture (water) may be removed to a containment sump discharge 355. The cooled biogas 304 may then be sent into a package #1 360 with clean makeup water 327 where package #1 360 where wastewater is removed from the biogas. The input to package #1 360 should preferably be maintained at a maximum of 1500 standard cubic feet per minute (SCFM). The package #1 360 outputs a package #1 product 305, an off-gas 306, and wastewater 521. Another output of package #1 360 may be soiled water 361 to be combined with trench sump discharge 324, which may include eyewash/shower 335 drain wastewater, where the water may be removed 370 and sent to the water treatment, and the oil 380 may then be sent to disposal.

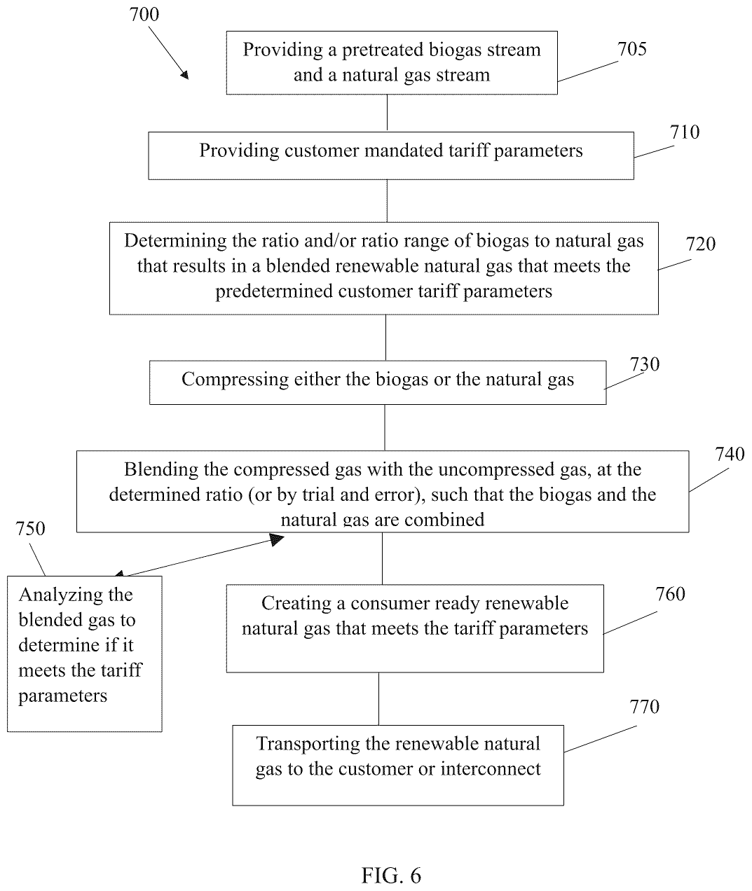

The package #1 gas product may be sampled at 332 and sent to a gas chromatograph, where the gas chromatographs will monitor CH₄, O₂, N₂, H₂0, H₂S, siloxanes in the gas stream along with the BTU value of the gas prior to its output of the package #1 360. The off-gas 306 moisture may be further removed. The off-gas 306 may dried and then may be burned off at OX-630 308 with natural gas (“NG”) 401 and vented to the atmosphere. The package #1 product 305 may be input into the Vendor Package 309, at a maximum of 900 psig, where it may be further cooled by the chilled water system 310. The output gas of the Vendor Package 309 may be sampled 333 and sent to a gas chromatograph (which may generate results, such as shown in FIG. 6a-6d), which may monitor CH₄, O₂, N₂, H₂0, H₂S, and siloxanes in the gas stream along with the BTU value of the gas. The output gas of Vendor Package 309 may then pass to the DEXO discharge 307. The DEXO discharge 307 output gas may be renewable natural gas product RNG 388, which is partially purified and is now 82.6% method. Thus, the partial purification process of FIGS. 4a-4c, increased the methane from 48.3% to 82.6%. The RNG 388 gas is now ready to be transported. In this case, the RNG 388 gas preferably enters or is transported to the VRNG plants 110 for dilution. The problem is that to further purify the partially purified gas is very expensive and requires additional purification equipment to be set up after transportation, but before entering the gas pipeline 140.

Any off-spec gas 390 may be returned to the LF blower 301 discharge and recycled back into the system or burned off.

FIGS. 4d-4g are a table showing one embodiment of the stream materials, properties, and mass flow. As shown in FIG. 4d-4g, table 1400 may comprise stream numbers 1402, which is a list of numbers from 1 to 30, most of which are shown within a diamond outline in FIGS. 4a-4c. The stream numbers 1402 show where in the stream of partially processing the raw biogas a sample may be taken and analyzed to determine the contents (materials) 1406, properties 1408, and mass flow 1410 of each sample at each stream number 1402. The table 1400 also provides the molecular weight 1420, freezing point 1422, and boiling point 1424, for each of the materials 1406. The analysis done to each sample may include analysis on a gas chromatograph.

The table 1400 also provides a stream label 1404 or name for each of the stream numbers 1-30. Importantly, stream numbers 8 to 16, and 23 (508, 509, 510, 511, 512, 513, 514, 515, 316, and 323) are not shown in FIGS. 4a to 4c.

The stream materials 1406 may include the fractional content of methane, carbon dioxide, nitrogen, oxygen, hydrogen sulfide, water, and ethane. The stream materials 1406 may also display the molecular weight (MW) average, Wobbe Index (in British thermal units per cubic foot (btu/cu.ft.)), and a total siloxanes (in milligrams per hour (mg/hr)).

The stream properties 1408 provided for each sample by stream number may include flow rate (scfm and gpm (gallons per minute), mass flow in pounds per hour (lb/hr), pressure (psig), and temperature (F). The mass flow 1410 may be provided for methane, carbon dioxide, nitrogen, oxygen, hydrogen sulfide, water, ethane.

FIGS. 4d-4g provide materials, properties, and mass flow for the following stream numbers:
1) LF Blower Discharge 301
2) Inlet Blower Feed 302
3) Inlet Blower Discharge 303
4) After Cooler Discharge 304
5) Product 305
6) Offgas 306
7) Deoxo Discharge 307
8) CPR STG 1 Inlet 508
9) CPR STG 1 Discharge 509
10) CPR STG 2 Discharge 510
11) Total NG Receive 511
12) Blend NG Preheated 512
13) Blend NG Letdown Discharge 513
14) Fuel NG Preheated 514
15) Fuel NG Treatment Site 515
16) Fuel NG to Turbines 316
17) Off-Spec gas 390
18) Condensate Sump Discharge 320
19) AFT Cool & Demister Condensate 322
20) Soiled Water 361
21) Wastewater 521
22) Containment Sump Discharge 355
23) Deoxo Condensate (mol fraction) 323
24) Trench Sump Discharge (mol fraction) 324
25) Total Potable Water (mol fraction)
26) Potable Water to Shower Station (mol fraction)
27) Makeup Water (mol fraction) 327
28) OWS Water Discharge 370
29) Oil Disposal 380
30) Eyewash/Shower (mol fraction) 335

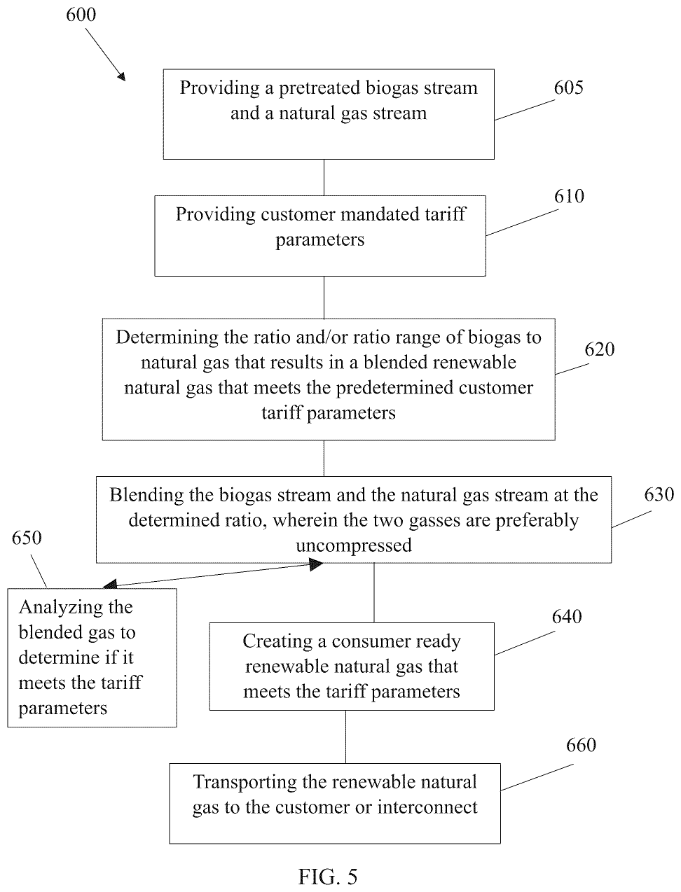

FIG. 5 is a flow block diagram of one embodiment of the method of biogas upgrading via blending without compression.

FIG. 6 is a detailed block diagram of the single stage compression biogas upgrading process.

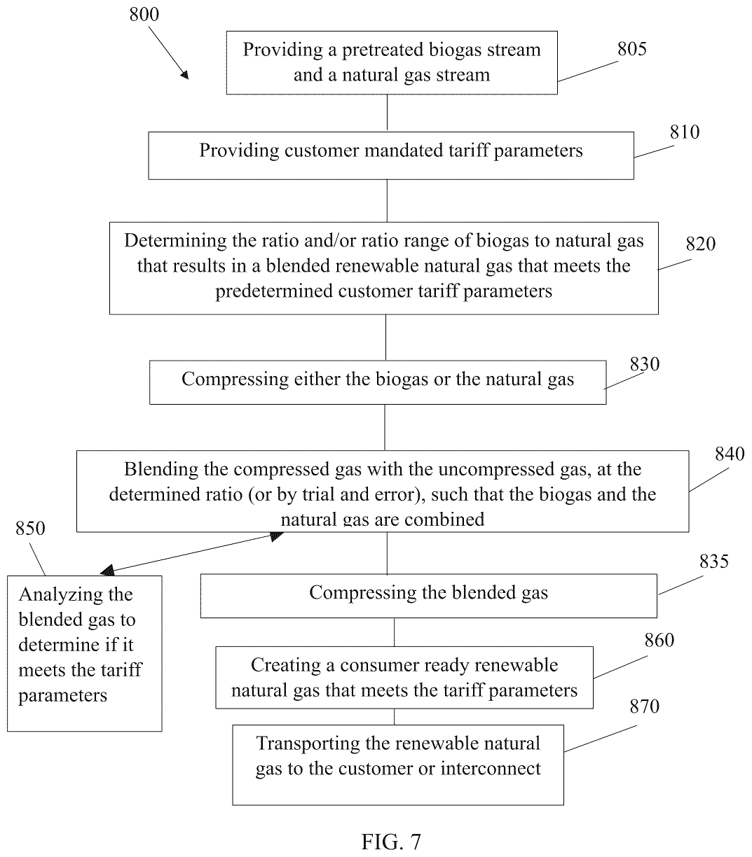

FIG. 7 is a detailed block diagram of the two-stage compression biogas upgrading process.

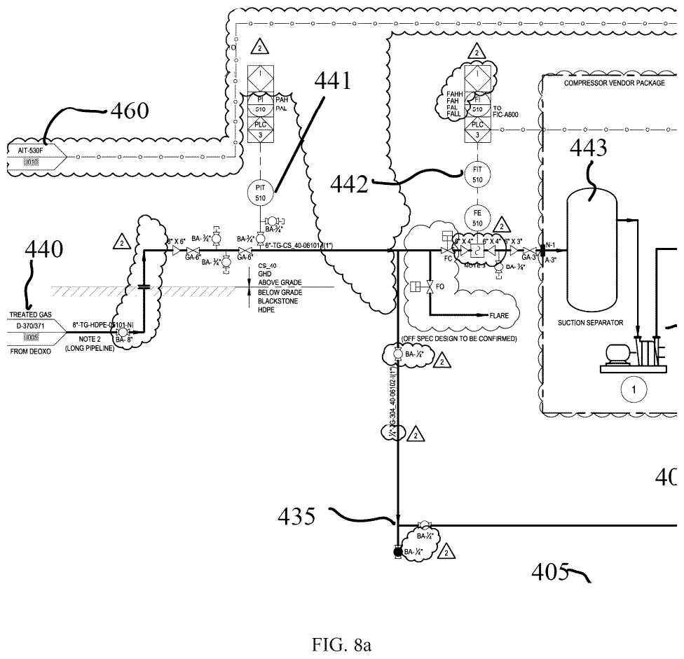

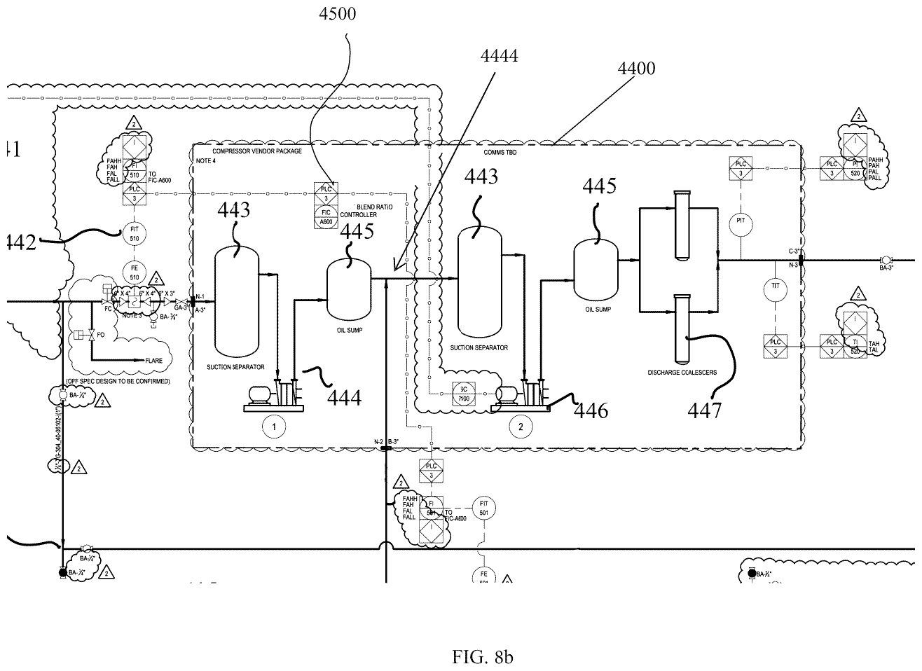

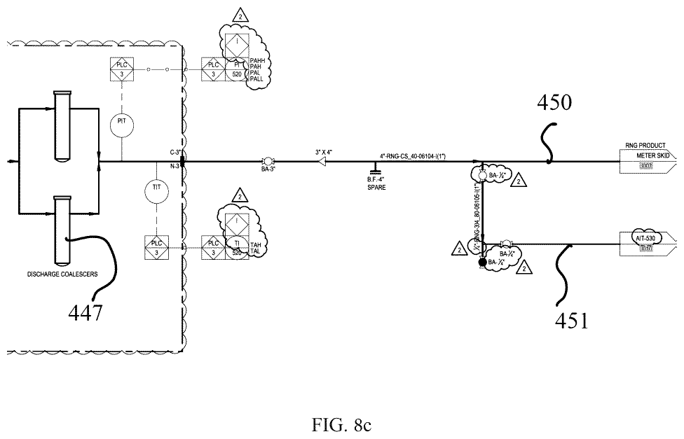

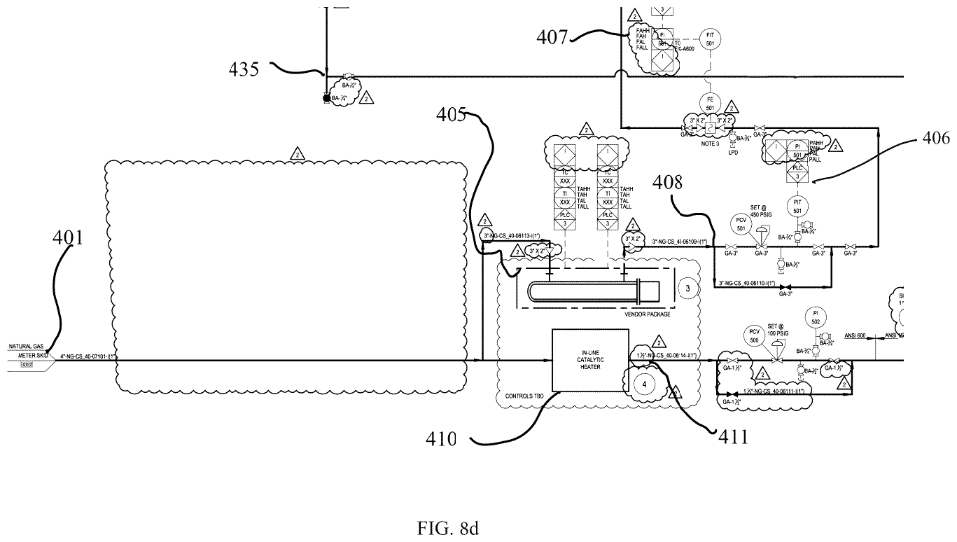

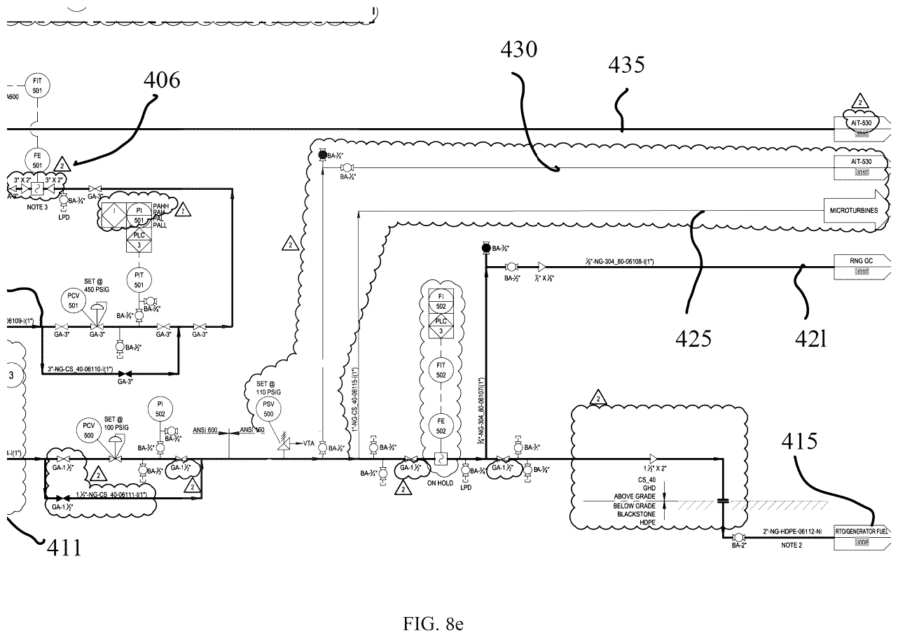

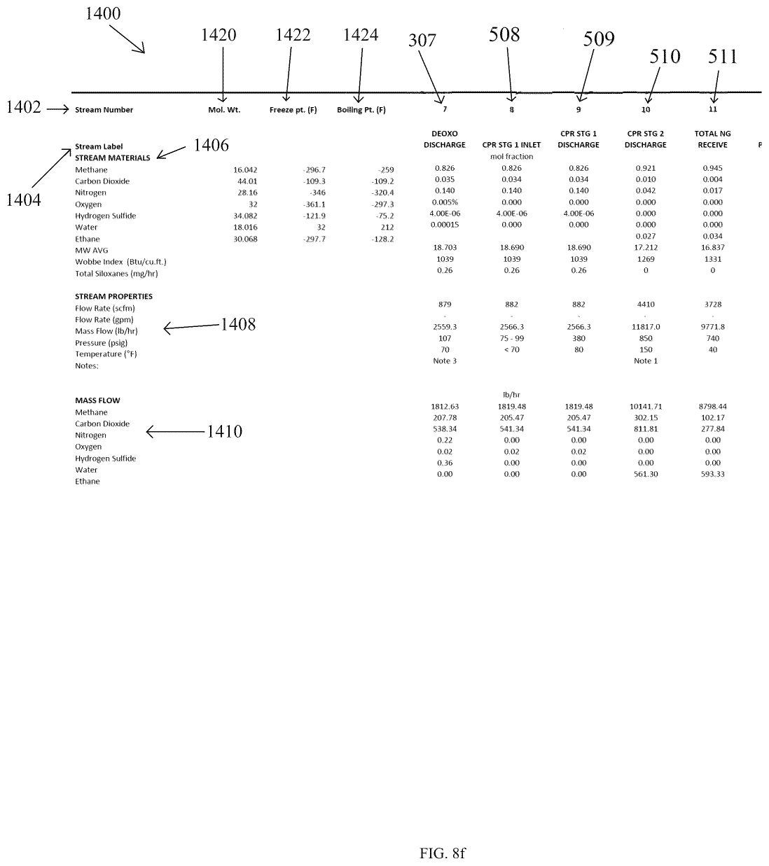

FIGS. 8a-8e are a functional diagram of one embodiment of the blending, injection piping, and instrumentation of the two-stage compression biogas upgrading process of FIG. 7. Although FIGS. 8a-8e are directly related to the method shown in FIG. 7, FIGS. 8a-8e may also be used to generally illustrate the blending, injection piping, and instrumentation of the two-stage stage compression biogas upgrading process by dilution shown in FIG. 6 and/or blending the biogas and brown gas shown in FIG. 5.

Referring to FIG. 5, the method 600 of blending without compression may comprise the steps: Providing a pretreated biogas stream and a natural gas stream 605; Blending the biogas stream and the natural gas stream at the determined ratio, wherein the two gasses are preferably uncompressed 630; Analyzing the blended gas to determine if it meets the tariff parameters 650; Creating a consumer ready renewable natural gas that meets the tariff parameters 640; and Transporting the renewable natural gas to the customer or interconnect 660. The method may also comprise: Providing customer mandated tariff parameters 610; and determining the ratio and/or ratio range of biogas to natural gas that results in a blended renewable natural gas that meets the predetermined customer tariff parameters 620.

In various embodiments, biogas blending methods may be accomplished by utilizing flow and/or pressure control valves with gas chromatographs to monitor and/or control the biogas and natural gas streams, which are blended in order to meet customer tariff parameters. Method 600 may comprise providing or inputting natural gas and a pretreated biogas from a landfill, industrial waste, or from agricultural waste sources. The pretreated biogas typically has a composition of methane, oxygen, nitrogen, water, hydrogen sulfide, and siloxanes, in amounts measured by a gas chromatograph sample from end of the partial purification process shown in FIGS. 4a-4c. The pretreated biogas may preferably have at least one of water or hydrogen sulfide substantially or completely removed. This reduces many of the corrosion problems and safety issues associated with transporting raw biogas.

As shown in FIGS. 8a-8c, the pretreated biogas may enter at the biogas input 440 at 65 to 120 psig through the first set of valves 441. The pretreated biogas constituents (typically methane, oxygen, nitrogen, water, hydrogen sulfide, and siloxanes) are measured, preferably by a gas chromatograph. Other equivalent analyzers may be used. The natural gas 401 may preferably be maintained at a pressure of 450 psig.

The tariff parameters may be provided 610, typically by the customer or entity that is purchasing the renewal natural gas product. The blend ratio may be determined 620, typically by: (i) analyzing the parameters and constituents of the pretreated biogas 440; (ii) analyzing the natural gas 401; and then (iii) calculating what ratio of biogas to natural gas will be within the tariff threshold parameters. In other embodiments, the blend ratio may be determined by trial and error and correcting the ratio in reaction to repeated analysis of the blend.

During the blending 630 of the two gas streams, a blend ratio controller 4500 controls a series of compressors and valves, such as meters and valves 406, which may control the natural gas 401 prior to blending. The flow indicator control 442 and blend ratio controller, may adjust the ratio and or flow of the pretreated biogas and/or natural gas, such that flow indicator control 442 and compressors and valves 406 effectively adjust the ratio and flow of the two gas streams, such that the blended renewable natural gas (RNG) product meets a set of tariff parameters at the RNG product output 450. The flow indicator control 442 and the series of meters and valves 406 may be manually or automatically triggered to control the flow and pressure of the two gas streams during the blending process in response to chromatograph analysis 650 of the combined gas when any blended stream constituent is off by more than 10% of the tariff parameters. The blending 630 may result in consumer ready renewable natural gas that meets the tariff parameters 640. The renewable natural gas (RNG product output 450) may be transported or otherwise provided to the customer.

The RNG product output 450 that is received by, or transported to, the tariff customer may preferably:
be merchantable natural gas that may be substantially free of water and liquid hydrocarbons;
contains no more than 7 pounds of water vapor per MMcf;
contains no more than 1.0 grain of hydrogen sulfide;
contains no more than 20 grains of total sulfur (reduced by sulfur caused by odorization equipment) per 100 cubic feet;
be no more than 2% carbon dioxide (by volume);
contains no more than 50 parts per million of oxygen;
contains no active bacteria or bacterial agents, including but not limited to sulfate-reducing bacteria and acid-producing bacteria;
contains no hazardous or toxic substances;
be 120° (degree) Fahrenheit (approximately 50° Celsius) or less in temperature; and
have a total or gross heating value of not less than nine hundred and fifty (950) BTU and not more than one thousand two hundred (1,200) BTU per cubic foot at the Point of Receipt by the client.

In the embodiment shown in FIG. 6, the biogas and NG blending, is accomplished by utilizing flow and/or pressure control valves with sample analysis (typically via gas chromatographs) to monitor and control the biogas and NG streams, which are blended together in order to meet predetermined customer tariff parameters. FIG. 6 shows that the method 700 of single stage compression blending may comprise: providing a pretreated biogas stream and a natural gas stream 705; providing customer mandated tariff parameters 710; Compressing either the biogas or the natural gas 730; blending the biogas and brown gas, such that the biogas and the natural gas are combined 740; Analyzing the blended gas to determine if it meets the tariff parameters 750 (repeatedly if necessary); Creating a consumer ready renewable natural gas that meets the tariff parameters 760; and Transporting the renewable natural gas to the customer or interconnect 770.

In other embodiments, the method may further comprise: Determining the ratio and/or ratio range of biogas to natural gas that results in a blended renewable natural gas that meets the predetermined customer tariff parameters 720 and then using that determined ratio to initially blend the two gas streams.

The biogas upgrading by dilution may start by providing or inputting 440 the pretreated biogas from a landfill, industrial waste, or agricultural waste. The pretreated biogas may have a composition of methane, oxygen, nitrogen, water, hydrogen sulfide, and siloxanes, in amounts measured by a gas chromatograph sample from end of the partial purification process shown in FIGS. 4a-4c. The pretreated biogas may preferably have at least one of water or hydrogen sulfide substantially or completely removed. This reduces many of the corrosion problems and safety issues associated with transporting raw biogas.

During the inputting 705 stage, the pretreated biogas passes a first set of valves 441. The first set of valves 441 indicates blending pressure and a flow indicator control 442 indicates gas flow. Blending is achieved at 705 by varying the revolutions per minute (“RPM”) of the second stated compressor to adjust the ratio and or flow of the biogas to the CPR STG 1 Inlet 508. Here the biogas enters suction separator 443, which contains the biogas as it is sent to first-stage compressor 444. The biogas then may be compressed at the first-stage compressor 444, the compressed biogas may be between 200 and 400 psig, and oils compressed out of the stream may be separated from the gas by oil separator 445. The natural gas 401 used for blending may optionally be treated in vendor package 405 and maintains a pressure of 740 psig. A series of pumps and valves 406 may control the pressure and flow of the natural gas 401 prior to blending. The flow indicator control 442, and the series of pumps and valves 406 may be triggered automatically (or, in some embodiments, manually) to control the flow and pressure during the blending process by the analyzers (which are typically chromatographs) when any of the constituents is off by more than 10% of the tariff parameters. The blended discharge 450, 760 may be output at a pressure of 450 to 600 psig.

The RNG product output 450 may preferably:
be merchantable natural gas that may be substantially free of water and liquid hydrocarbons;
contains no more than 7 pounds of water vapor per MMcf;
contains no more than 1.0 grain of hydrogen sulfide;
contains no more than 20 grains of total sulfur (reduced by sulfur caused by odorization equipment) per 100 cubic feet;
be no more than 2% carbon dioxide (by volume);
contains no more than 50 parts per million of oxygen;
contains no active bacteria or bacterial agents, including but not limited to sulfate-reducing bacteria and acid-producing bacteria;
contains no hazardous or toxic substances;
be 120° (degree) Fahrenheit (approximately 50° Celsius) or less in temperature; and
have a total or gross heating value of not less than nine hundred and fifty (950) BTU and not more than one thousand two hundred (1,200) BTU per cubic foot at the Point of Receipt by the client.

In other embodiments, it is the natural gas that is compressed and is then mixed with an uncompressed pretreated biogas.

In the embodiment shown in FIG. 7, the biogas blending, may be accomplished by utilizing flow and/or pressure control valves with gas chromatographs to monitor and/or control the biogas and hydrocarbon gas streams, which are blended together in order to meet customer tariff parameters.

Preferably, the two-stage compression biogas upgrading method 800 may comprise: Providing a pretreated biogas stream and a natural gas stream 805; Compressing either the biogas or the natural gas 830; Blending the biogas and brown gas, at the determined ratio (or by trial and error), such that the biogas and the natural gas are combined 840; Analyzing the blended gas to determine if it meets the tariff parameters 850; Compressing the blended gas 835; Creating a consumer ready renewable natural gas that meets the tariff parameters 860; and Transporting the renewable natural gas to the customer or interconnect 870.

The method 800, in various embodiments may further comprise: Providing customer mandated tariff parameters 810; and determining the ratio and/or ratio range of biogas to natural gas that results in a blended renewable natural gas that meets the predetermined customer tariff parameters 820.

The first step of method 800 may be to provide or input pretreated biogas 805 from a landfill, industrial waste, or from agricultural waste sources. The pretreated biogas may have a composition of methane, oxygen, nitrogen, water, hydrogen sulfide, and siloxanes, in amounts measured by a gas chromatograph sample from end of the partial purification process shown in FIGS. 4a-4c. The pretreated biogas may preferably have at least one of water or hydrogen sulfide substantially or completely removed. This reduces many of the corrosion problems and safety issues associated with transporting raw biogas.

During the inputting 805 stage, the biogas passes a first set of valves 441. The first set of valves 441 controls the initial pressure and flow of the pretreated biogas, preferably in the range of 65 to 120 psig. This stage may be where the constituents of the pretreated biogas, namely, methane, oxygen, nitrogen, water, hydrogen sulfide, and siloxanes are measured or analyzed using a gas chromatograph or an equivalent analyzer. The flow indicator control 442 may adjust the ratio and or flow of the biogas to the CPR STG 1 Inlet 508. The biogas may then enter the compression vendor package 4400, which preferably has two compressors 444 and 446. Upon entering the compression vendor package 4400, the biogas may enter the suction separator 443, which contains the biogas until it is compressed at the first-stage compressor 444, the biogas may be now between 200 and 400 psig, and oils are separated by an oil separator 445. The natural gas 401 used for blending may optionally be treated in vendor package 405 and maintains a pressure of 740 psig. A series of pumps and valves 406 control the natural gas 401 prior to combining the two gas streams at junction 4444. The flow indicator control 442, and the series of pumps and valves 406 are triggered (automatically or manually) to control the flow and pressure of the biogas during the blending at junction 4444 by the chromatographs when the parameters of any constituent of the blended gas is off by more than 10% of the tariff parameters.

The blended biogas and natural gas may be then collected at a second suction separator 443 and then compressed at second-stage compressor 446, where the blended gas may be further compressed to 380 psig to 600 psig. The second-stage compressor 446 receives control signals from communications cable 460 these signals control revolutions per minute (“RPM”), flow rate, and pressure that that may be based on measurements. The blended discharge may be output at a pressure of 850 to 1440 psig.

The RNG product output 450 may preferably:
be merchantable natural gas that may be substantially free of water and liquid hydrocarbons;
contains no more than 7 pounds of water vapor per MMcf;
contains no more than 1.0 grain of hydrogen sulfide;
contains no more than 20 grains of total sulfur (reduced by sulfur caused by odorization equipment) per 100 cubic feet;
be no more than 2% carbon dioxide (by volume);
contains no more than 50 parts per million of oxygen;
contains no active bacteria or bacterial agents, including but not limited to sulfate-reducing bacteria and acid-producing bacteria;
contains no hazardous or toxic substances;
be 120° (degree) Fahrenheit (approximately 50° Celsius) or less in temperature; and
have a total or gross heating value of not less than nine hundred and fifty (950) BTU and not more than one thousand two hundred (1,200) BTU per cubic foot at the Point of Receipt by the client.

Further referring to FIGS. 8a-8e, one embodiment of the blending, injection piping, and instrumentation may be a two-stage compression biogas upgrading process. Although FIGS. 8a-8e are directly related to the method shown in FIG. 7, FIGS. 8a-8e may also be used to generally illustrate the blending, injection piping, and instrumentation of the single stage compression biogas upgrading process by dilution shown in FIG. 6 and/or blending without compression shown in FIG. 5.

FIGS. 8a-8e show the process and preferred instrumentation for blending the partially purified biogas and already tariff approved and purified natural gas. The blending of the biogas and the natural gas may be achieved through monitoring the compositions of both gas streams within the system and adjusting the flow rate of either gas stream to achieve the desired mix ratio of the gas streams in order to dilute the biogas stream to the specified customer requirements, which can include, but are not limited to, minimum and maximum heating value (BTU), Wobbe minimum and maximum, total sulfur, hydrogen sulfide, carbon dioxide, nitrogen, oxygen, and total inert gases percent composition within the gas stream.

The blending process dilutes the non-methane constituents in the biogas by adding natural hydrocarbon gas (methane) to achieve the desired gas composition requirements. Without blending, full purification treatment would need to be conducted to sell the biogas as a renewable natural gas.

In some embodiments, the natural gas can be the compressed gas before blending in the first-stage compressor, rather than the pretreated biogas.

As shown in FIGS. 8a-8e, the natural gas 401 that is used to blend with renewable natural gas product RNG 388, which is partially purified, enters and between 65 and 120 psig. The output of the vendor package 405 may be controlled by a series of pumps and valves 406 before entering the compressor vendor package 4400 and being blended with the first-stage compressed biogas at junction 4444. Preferably, the biogas from the first-stage compressor 444 and oil sump 445 are compressed and the typical compression at the first-stage compressor 444 can range from 200 psig to 400 psig with the discharge pressure ranging from 450 psig to 600 psig.

An in-line catalytic heater 410 uses a catalyzing chemical reaction to produce heat. The catalytic heater 410 generates heat without a flame, which is ideal when used with flammable gases, such as biogas and natural gas. The catalytic heater 410 prevents the natural gas stream from freezing and hydrate formation in pipelines and measurement instruments. These are commonly experienced problems when gas pressures fluctuate. The natural gas output 411 from the in-line catalytic heater 410 may then be sent to the regenerative thermal oxidizer (“RTO”)/Generator Fuel 415, biogas chromatograph 420, where the gas chromatographs will monitor methane, oxygen, nitrogen, water, hydrogen sulfide, and siloxanes in the gas stream along with the BTU value of the gas, microturbines 425.

The RTO/Generator Fuel 415 is an output of the catalytic heater 410 used to control the volatile organic compounds, hazardous pollutants, and odors by converting the carbon dioxide and water of the partially treated biogas through the use of heat before exhausting them to the atmosphere. The natural gas chromatograph 420 output may be where the natural gas 401 may be chemically tested to determine the different components of the natural gas 401 mixture by injecting a gaseous sample into a mobile phase and passing the gas through a stationary phase. Microturbines 425 offset carbon dioxide emissions by operating off the captured methane. Microturbine systems are small gas turbine generation packages designed to provide on-site power and thermal energy with low emissions and low maintenance requirements. Microturbines 425 use lean premix combustion systems for low Nitrogen Oxides (“NOx”) and Carbon Monoxide (“CO”) emissions. Microturbines 425 were originally designed to burn natural gas and to be used in commercial and industrial cogeneration applications. They have now been adapted for use with biogas, flare gases, and other waste fuels.

The biogas input 440 is where the partially treated biogas, from the landfill 100, industrial waste 101, or agricultural waste 102 enters at 65 to 120 psig and begins the blending 203 processes. The partially treated Biogas 201 from the biogas input 440, first set of valves 441 control the flow and ratio of biogas to be blended. A first set of valves 441, where the flow and ratio are controlled to maintain the desirable ration, which may typically be in the range of four to eight parts pretreated biogas to one-part natural gas (4:1 to 8:1). The set points for the first set of valves 441 can be of any value below tariff specifications. Preferably to maintain a measured output at the final gas chromatograph 451 of methane, oxygen, nitrogen, water, hydrogen sulfide, and siloxanes in the gas stream are not off by more than 10% of the tariff parameters for each constituent.

The RNG product output 450 may preferably:
be merchantable natural gas that may be substantially free of water and liquid hydrocarbons;
contains no more than 7 pounds of water vapor per MMcf;
contains no more than 1.0 grain of hydrogen sulfide;
contains no more than 20 grains of total sulfur (reduced by sulfur caused by odorization equipment) per 100 cubic feet;
be no more than 2% carbon dioxide (by volume);
contains no more than 50 parts per million of oxygen;
contains no active bacteria or bacterial agents, including but not limited to sulfate-reducing bacteria and acid-producing bacteria;
contains no hazardous or toxic substances;
be 120° (degree) Fahrenheit (approximately 50° Celsius) or less in temperature; and
have a total or gross heating value of not less than nine hundred and fifty (950) BTU and not more than one thousand two hundred (1,200) BTU per cubic foot at the Point of Receipt by the client.

Flow indicator control 442, may allow a specified amount of the pretreated biogas into compressor vendor package and on to suction separator 443 which contains the biogas (or in some embodiments the natural gas, depending on which gas is being compressed before blending). The biogas in the suction separator 443 may pass into the first-stage compressor 444 where the input biogas may be compressed to 200 to 400 psig and then sent to an oil sump 445 to remove any oils that have leaked out due to the compression. The compressed biogas may be blended with the natural gas at junction 4444. The blended gas may then be sent to a second suction separator 443. where it may then be compressed in the second-stage compressor 446 to 380 to 600 psig.

The required blend ratio may be maintained via Flow indicator control 442 (biogas stream) and the series of pumps and valves 406 (natural gas stream). Flow indicator control 442 and the series of pumps and valves 406 may be preset once a ratio is determined. In other embodiments the Flow indicator control 442 and the series of pumps and valves 406 may manually or automatically be triggered to control the flow and pressure of the two gas streams during the blending process. In other embodiments, maintaining an acceptable blending ratio may be achieved through the 1st and/or 2nd stage compressor motor controls. The motor controls will either reduce or increase flow to achieve the desired blend ratio to stay within customer tariff gas composition requirements. Typically, the ratio of biogas to natural gas is in the range of four-to-one to eight-to-one. The Flow indicator control 442 (biogas stream) and the series of pumps and valves 406 may either increase or decrease the blend ratio to maintain the blended gas within the required customer tariff gas composition requirements (parameters). A final gas chromatograph 451 at the RNG product output 450 may monitor the end RNG product.

FIG. 8f is a table showing one embodiment of the stream materials, properties, and mass flow for the biogas dilution method of the present disclosure. As shown in FIG. 8d, table 1400 may comprise stream numbers 1402, which is a list of numbers from 1 to 30, only 7-11 are shown in FIG. 8d. The stream numbers 1402 show where in the blending stream gas samples may be taken and analyzed to determine the contents (materials) 1406, properties 1408, and mass flow 1410 of each sample at each stream number 1402. The table 1400 also provides the molecular weight 1420, freezing point 1422, and boiling point 1424, for each of the materials 1406. The analysis done to each sample may include analysis on a gas chromatograph. The table 1400 shows the stream materials methane, carbon dioxide, nitrogen, oxygen, hydrogen sulfide, water, ethane, molecular weight (“MW”) Average, Wobbe index, and total siloxanes. The table further shows the stream properties flow rate in standard cubic meter (“SCM”) and in gallon per minute (“gpm”), mass flow, pressure, and temperature. The mass flow of methane, carbon dioxide, nitrogen, oxygen, hydrogen sulfide, water, and ethane are also represented in the table. Compression stage (“CPR STG”) 1 inlet 508, CPR STG 1 discharge 509, CPR STG 2 discharge 510, and TOTAL NG received 511 are the parameters that pertain to the biogas and hydrocarbon blending related to FIGS. 8a-8e. Balance may be based on max flows throughout and includes a four-to-one blending ratio of biogas (LFG, which stands for landfill gas) and natural gas (line gas). The mass balance design data listed are based on package #1's best case 1500 scfm.

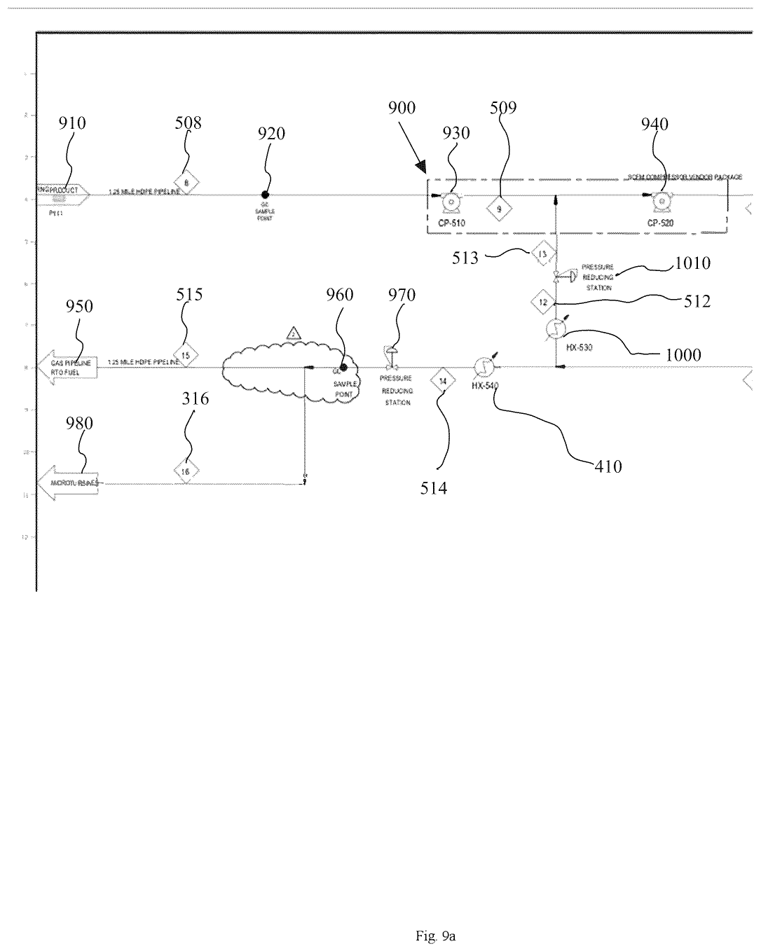

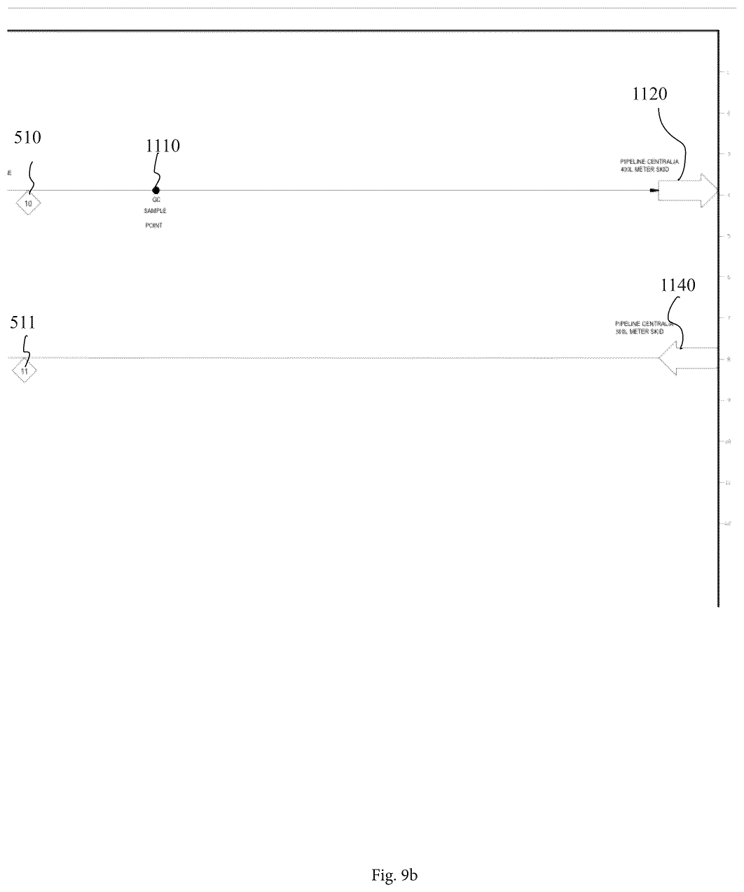

FIG. 9a-9b are a functional diagram of one embodiment of the blending, injection piping, and instrumentation of the two-stage compression biogas upgrading process of FIG. 7. The biogas blending may be accomplished by utilizing flow and/or pressure control valves with gas chromatographs to monitor and/or control the biogas and hydrocarbon gas streams, which may be blended together in order to meet customer tariff parameters.

Preferably, the two-stage compression biogas upgrading method 800, as shown in FIG. 7, may comprise: Providing a pretreated biogas stream 910, initially measured at CPR STG 1 Inlet 508, and a natural gas stream 1140; and Measuring total received natural gas 511.

The CPR STG 1 inlet 508 biogas stream may be sampled at 920 prior to entering the two-stage compression vendor package 900. The biogas may be initially pressurized at the first-stage compressor 930 and discharged at CPR STG 1 discharge 509 where it may be blended with the blend natural gas let down discharge 513. The blended gas from CPR STG 1 discharge 509 and blend natural gas let down discharge 513 may be further compressed by the second-stage compressor 940. The two-stage compression vendor package 900 outputs the blended gas at CPR STG 2 discharge 510 where the blended gas may be sampled at 1110 where the compressed gas stream may be analyzed to determine if it meets the tariff parameters 850 prior to supplying an end RNG product output 1120. The second-stage compressor 940 may also preferably bring the pressure of the blended gas to the correct pressure to allow it to enter the gas pipeline at or after end RNG product output 1120.

The total received natural gas 511 may be preheated at an in-line catalytic heater 1000 and measured at blend natural gas preheated 512 prior to having its pressure reduced by a pressure reducing station 1010. The pressure reduced gas stream of pressure reducing station 1010 may be discharged and measured as blend natural gas letdown discharge 513. The blend natural gas letdown discharge 513 gas stream may be blended with the gas stream at CPR STG 1 discharge 509. The total received natural gas may also preheated at an in-line catalytic heater 410 where fuel natural gas preheated 514 may be measured. The fuel natural gas preheated 514 gas stream may enter pressure reducing station 970 where the pressure may be reduced and sampled at 960. The gas sampled at 960 may supply fuel natural gas to power the treatment site 515 and Fuel NG to Turbines 316. The fuel natural gas to treatment site 515, may supply a thermal oxidizer (“RTO”) 950, which may be used to control the volatile organic compounds, hazardous pollutants, and odors by converting the carbon dioxide and water of the partially treated biogas through the use of heat before exhausting them to the atmosphere. Fuel NG to Turbines 316 may supply Microturbines 980 that may be used to offset carbon dioxide emissions by operating off the captured methane.

The blending occurs at the CPR STG 1 Inlet 508 and the blend natural gas letdown discharge 513. The blended biogas and natural gas may be further compressed at a second-stage compressor 940, where the blended gas may be further compressed to 380 psig to 600 psig or to match with the desired pipeline pressure.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded. As illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for upgrading biogas comprising:
providing a pretreated biogas stream;
providing a natural gas stream;
controlling a pressure and a flow of said pretreated biogas stream;
controlling a pressure and a flow of said natural gas stream;
blending together said pretreated biogas stream and said natural gas stream to create a blended gas product;
analyzing said blended gas product to determine if a plurality of tariff parameters are substantially met; and
adjusting an actual ratio of said pretreated biogas stream to said natural gas stream, such that said blended gas product meets said plurality of tariff parameters, such that a renewable natural gas product is created.

2. The method of claim 1, further comprising:
providing said plurality of tariff parameters before blending;
analyzing said pretreated biogas stream before blending;
analyzing said natural gas stream before blending; and
determining an optimal ratio of said pretreated biogas stream to said natural gas stream that will meet said plurality of tariff parameters;
wherein said blending is initially done at said optimal ratio that was determined.

3. The method of claim 1, further comprising:
transporting said renewable natural gas product to a gas pipeline interconnect.

4. The method of claim 1, wherein adjusting said actual ratio of said pretreated biogas stream to said natural gas stream is done via adjusting said pressure and said flow of said pretreated biogas stream and adjusting said pressure and said flow of said natural gas stream.

5. The method of claim 1, wherein said pretreated biogas is obtained from at least one of a landfill, an industrial waste site, and an agricultural waste site.

6. The method of claim 1, wherein said analyzing of said blended gas product is done via gas chromatography.

7. The method of claim 1, wherein said adjusting said actual ratio of said pretreated biogas stream to said natural gas stream is done automatically in response to said analyzing of said blended gas product.

8. The method of claim 1, further comprising:
compressing either said pretreated biogas stream or said natural gas before blending them together.

9. The method of claim 8, wherein said pretreated biogas stream is compressed and said natural gas is uncompressed.

10. The method of claim 1, wherein both said biogas stream and said natural gas stream are uncompressed before blending.

11. The method of claim 8, further comprising:
compressing said blended gas product.

12. The method of claim 9, further comprising:
compressing said blended gas product.

13. The method of claim 1, wherein said renewable natural gas product is (i) a merchantable natural gas that may be substantially free of water and liquid hydrocarbons, (ii) contains no more than 7 pounds of water vapor per MMcf, (iii) contains no more than 1.0 grain of hydrogen sulfide, (iv) contains no more than 20 grains of total sulfur per 100 cubic feet, (v) no more than 2% carbon dioxide (by volume), (vi) contains no more than 50 parts per million of oxygen, (vii) contains no active bacteria or bacterial agents, contains no hazardous or toxic substances, and (viii) have a total or gross heating value of not less than nine hundred and fifty (950) BTU and not more than one thousand two hundred (1,200) BTU per cubic foot.

14. A method for upgrading biogas comprising:
providing a pretreated biogas stream;
providing a natural gas stream;
controlling a pressure and a flow of said pretreated biogas stream;
controlling a pressure and a flow of said natural gas stream;
compressing said pretreated biogas stream;
blending together said compressed pretreated biogas stream and said natural gas stream to create a blended gas product;
analyzing said blended gas product to determine if a plurality of tariff parameters are substantially met; and
adjusting automatically an actual ratio of said compressed pretreated biogas stream to said natural gas stream in response to said analyzing of said blended gas product, such that said blended gas product meets said plurality of tariff parameters, such that a renewable natural gas product is created.

15. The method of claim 14, further comprising:
providing said plurality of tariff parameters before blending;
analyzing said pretreated biogas stream before blending;
analyzing said natural gas stream before blending; and
determining an optimal ratio of said pretreated biogas stream to said natural gas stream that will meet said plurality of tariff parameters;
wherein said blending is done at said optimal ratio that was determined;
wherein adjusting said actual ratio of said pretreated biogas stream to said natural gas stream is done via adjusting said pressure and said flow of said pretreated biogas stream and adjusting said pressure and said flow of said natural gas stream; and
wherein said analyzing of said blended gas product is done via gas chromatography.

16. The method of claim 14, further comprising:
compressing said blended gas product.

17. The method of claim 14, wherein said pretreated biogas is obtained from at least one of a landfill, an industrial waste site, and an agricultural waste site.

18. A method for upgrading biogas comprising:
providing a pretreated biogas stream;
providing a natural gas stream;
controlling a pressure and a flow of said pretreated biogas stream;
controlling a pressure and a flow of said natural gas stream;
compressing said pretreated biogas stream;
blending together said compressed pretreated biogas stream and said natural gas stream to create a blended gas product;
compressing said blended gas product;
analyzing said blended gas product to determine if a plurality of tariff parameters are substantially met; and
adjusting automatically an actual ratio of said compressed pretreated biogas stream to said natural gas stream in response to said analyzing of said blended gas product, such that said blended gas product meets said plurality of tariff parameters, such that a renewable natural gas product is created;
wherein said pretreated biogas is obtained from at least one of a landfill, an industrial waste site, and an agricultural waste site.

19. The method of claim 18, further comprising:
providing said plurality of tariff parameters before blending;
analyzing said pretreated biogas stream before blending;
analyzing said natural gas stream before blending; and
determining an optimal ratio of said pretreated biogas stream to said natural gas stream that will meet said plurality of tariff parameters;
wherein said blending is done at said optimal ratio that was determined;
wherein adjusting said actual ratio of said pretreated biogas stream to said natural gas stream is done via adjusting said pressure and said flow of said pretreated biogas stream and adjusting said pressure and said flow of said natural gas stream; and
wherein said analyzing of said blended gas product is done via gas chromatography.

20. The method of claim 19, further comprising:
transporting said renewable natural gas product to a gas pipeline interconnect.
